(19) United States
(12) Patent Application Publication
(10) Pub. No.: US 2015/0043532 A1
(43) Pub. Date: Feb. 12, 2015

(54) COMMUNICATION CONTROL METHOD, BASE STATION, HOME BASE STATION, AND GATEWAY DEVICE

(71) Applicant: KYOCERA CORPORATION, Kyoto-shi, Kyoto (JP)

(72) Inventors: Hiroyuki Adachi, Kawasaki-shi (JP); Kugo Morita, Yokohama-shi (JP)

(21) Appl. No.: 14/384,701

(22) PCT Filed: Mar. 15, 2013
(86) PCT No.: PCT/JP2013/057515

§ 371 Date: Sep. 12, 2014

Related U.S. Application Data
(60) Provisional application No. 61/612,049, filed on Mar. 16, 2012.
(60) Provisional application No. 61/612,003, filed on Mar. 16, 2012.
(60) Provisional application No. 61/612,014, filed on Mar. 16, 2012.

(51) Int. Cl. H04W 36/00; H04W 12/08

(52) U.S. Cl. CPC H04W 36/0033; H04W 12/08; H04W 36/0083
USPC 370/331

(57) ABSTRACT

A communication control method applied to a mobile communication system, the mobile communication system including a home base station that forms a specific cell, a base station that determines whether to perform handover of a user terminal to the specific cell and a mobility management device that performs verification of the user terminal for access permission to the specific cell, the communication control method comprises a request step of requesting the mobility management device to perform the verification of the user terminal before the base station determines to perform the handover to the specific cell.

### TECHNICAL FIELD

The present invention relates to a communication control method and a base station in a mobile communication system.

### BACKGROUND ART

In 3GPP (3rd Generation Partnership Project) which is a project aiming to standardize a mobile communication system, specifications of a home base station, which is a small base station provided in a home or a company, are discussed (see Non Patent Document 1).

A home base station forms a specific cell such as a CSG (Closed Subscriber Group) cell or a hybrid cell. The CSG cell is a cell accessible only by a user terminal (called a “CSG member”) having an access permission. The hybrid cell is accessible by other terminals other than the CSG member, but the CSG member is advantageously treated.

In addition, it is noted that a “cell” is used as a term indicating a minimum unit of a radio communication area, and is also used as a term indicating a function of performing radio communication with a user terminal.

In a handover procedure of a user terminal to a specific cell, a mobility management device included in a core network performs verification (access control) of the user terminal for access permission to the specific cell.

### PRIOR ART DOCUMENT

### Non-Patent Document

[Non-patent Document 1] 3GPP technology specifications “TS 36.300 V11.0.0” December, 2011

### SUMMARY OF THE INVENTION

However, when the mobility management device performs the verification of the user terminal in the course of the handover procedure, the handover procedure via the core network should be performed. Therefore, there is a problem that much time is required for the handover procedure and traffic of the core network is increased.

Therefore, an object thereof is to provide a communication control method and a base station, by which it is possible to efficiently perform a handover procedure to a specific cell.

A communication control method of the present invention is a communication control method applied to a mobile communication system including a home base station that forms a specific cell, a base station that determines whether to perform handover of a user terminal to the specific cell, and a mobility management device that performs verification of the user terminal for access permission to the specific cell, and the communication control method comprises a request step of requesting, by the base station, the mobility management device to perform the verification of the user terminal before the base station determines to perform the handover to the specific cell.

### BRIEF DESCRIPTION OF THE DRAWINGS

FIG. 1 is a configuration diagram of a mobile communication system according to a first embodiment and a second embodiment.

FIG. 2 is a configuration diagram of a radio frame used in the mobile communication system.

FIG. 3 is a block diagram of UE.

FIG. 4 is a block diagram of eNB.

FIG. 5 is a block diagram of MME.

FIG. 6 is a block diagram of HeNB.

FIG. 7 is a block diagram of HeNB GW.

FIG. 8 is a flowchart of a pre-verification determination process in eNB according to the first embodiment.

FIG. 9 is a sequence diagram of an operation sequence 1 according to the first embodiment.

FIG. 10 is a sequence diagram of an operation sequence 2 according to the first embodiment.

FIG. 11 is a sequence diagram of an operation sequence 3 according to the first embodiment.

FIG. 12 is a sequence diagram of an operation sequence 4 according to the first embodiment.

FIG. 13 is an operation sequence diagram of the mobile communication system according to the second embodiment.

FIG. 14 is an operation flowchart of the HeNB according to the second embodiment.

FIG. 15 is a configuration diagram of a mobile communication system according to a third embodiment.

FIG. 16 is an operation sequence diagram of the mobile communication system according to the third embodiment.

FIG. 17 is an operation flowchart of the HeNB according to the third embodiment.

### DESCRIPTION OF EMBODIMENTS

### Overview of Embodiment

A communication control method according to an embodiment is applied to a mobile communication system including a home base station that forms a specific cell, a base station that determines whether to perform handover of a user terminal to the specific cell, and a mobility management device that performs verification of the user terminal for access permission to the specific cell. The communication control method comprises a step of requesting the mobility management device to perform the verification of the user terminal before the base station determines to perform the handover to the specific cell.

In this way, the mobility management device performs the verification (hereinafter, referred to as “pre-verification”) of the user terminal at a stage before a handover procedure, so that it is possible to omit the verification of the user terminal by the mobility management device in the course of the handover procedure. Consequently, it is possible to efficiently perform the handover procedure to the specific cell.

The communication control method according to a first embodiment comprises the step that the base station requests the mobility management device to perform the verification of the user terminal before the base station determines to perform the handover to the specific cell.

The communication control method according to the first embodiment further comprises a step of holding, by the base station, a verification result obtained from the mobility management device.

The communication control method according to the first embodiment further comprises a step of transmitting, by the base station, a handover request to the home base station when the base station determines to perform the handover to the specific cell on the basis of a measurement report from the user terminal and when a verification result indicating verification success is obtained from the mobility management device.

The communication control method according to the first embodiment further comprises a step of requesting, by the base station, the mobility management device to perform the verification of the user terminal when the base station determines to perform the handover to the specific cell on the basis of the measurement report from the user terminal and when the verification result indicating the verification success is not obtained from the mobility management device.

The communication control method according to the first embodiment further comprises a step of transmitting, by the base station, information on the verification result from the mobility management device to the home base station together with a handover request when the base station determines to perform the handover to the specific cell on the basis of a measurement report from the user terminal.

The communication control method according to the first embodiment further comprises a step of permitting, by the home base station, the handover request from the base station in response to a fact that information on the verification result from the base station indicates verification success.

The communication control method according to the first embodiment further comprises a step of requesting, by the home base station, the mobility management device to perform the verification of the user terminal in response to a fact that the information on the verification result from the base station indicates that a verification result indicating verification success is not obtained.

The communication control method according to a second embodiment, comprises a request step that the home base station requires the mobility management device to perform the verification of the user terminal before the base station determines to perform the handover to the specific cell.

The communication control method according to the second embodiment, further comprises a notification step of notifying, by the base station, the home base station of information of each of the specific cell and the user terminal on the basis of a measurement report received from the user terminal before determining to perform the handover to the specific cell. In the request step, the home base station requests the mobility management device to perform the verification of the user terminal on the basis of the information notified from the base station.

In this way, at a stage before the handover procedure, the information to be used in the pre-verification is notified to the home base station, so that the home base station is able to appropriately request the mobility management device to perform the verification of the user terminal.

The communication control method according to the second embodiment, further comprises a holding step of holding, by the home base station, a verification result obtained from the mobility management device in response to a request in the request step.

The communication control method according to the second embodiment, further comprises a transmission step of transmitting, by the base station, a handover request to the home base station when the base station determines to perform the handover to the specific cell and a step of determining, by the home base station, whether to permit the handover request from the base station on the basis of the verification result held in the holding step.

A communication control method according to a third embodiment is applied to a mobile communication system including a home base station that forms a specific cell, a base station that determines whether to perform handover of a user terminal to the specific cell, a mobility management device that performs verification of the user terminal for access permission to the specific cell, and a gateway device that manages the home base station. The communication control method comprises a request step that the gateway device requests the mobility management device to perform the verification of the user terminal before the base station determines to perform the handover to the specific cell.

The communication control method according to the third embodiment further comprises a notification step of notifying, by the base station, the gateway device of information of each of the specific cell and the user terminal on the basis of a measurement report received from the user terminal before determining to perform the handover to the specific cell, and in the request step, the gateway device requests the mobility management device to perform the verification of the user terminal on the basis of the information notified from the base station.

In this way, at a stage before the handover procedure, the information to be used in the pre-verification is notified to the gateway device, so that the gateway device is able to appropriately request the mobility management device to perform the verification of the user terminal.

The communication control method according to the third embodiment, further comprises a holding step of holding, by the gateway device, a verification result obtained from the mobility management device in response to a request in the request step.

The communication control method according to claim 15, further comprises a transmission step of transmitting, by the base station, a handover request to the gateway device when the base station determines to perform the handover to the specific cell and a step of determining, by the gateway device, whether to permit the handover request from the base station on the basis of the verification result held in the holding step.

A base station according to the first embodiment determines whether to perform handover of a user terminal to a specific cell in a mobile communication system including a home base station that forms a specific cell and a mobility management device that performs verification of the user terminal for access permission to the specific cell. The base station comprises a control unit that controls to request the mobility management device to perform the verification of the user terminal before it is determined to perform the handover to the specific cell.

A home base station according to the second embodiment forms a specific cell in a mobile communication system including a base station that determines whether to perform handover of a user terminal to the specific cell and a mobility management device that performs verification of the user terminal for access permission to the specific cell. The home base station comprises a control unit that controls to request the mobility management device to perform the verification of the user terminal before the base station determines to perform the handover to the specific cell.

A base station according to the second embodiment determines whether to perform handover of a user terminal to a specific cell in a mobile communication system including a home base station that forms a specific cell and a mobility management device that performs verification of the user terminal for access permission to the specific cell. The base station comprises a control unit that controls to notify the home base station of information of each of the specific cell and the user terminal on the basis of a measurement report received from the user terminal before determining to perform the handover to the specific cell. The information notified by the control unit is used when the home base station requests the mobility management device to perform the verification of the user terminal.

A gateway device according to the third embodiment manages a home base station in a mobile communication system including the home base station that forms a specific cell, a base station that determines whether to perform handover of a user terminal to the specific cell, and a mobility management device that performs verification of the user terminal for access permission to the specific cell. The gateway device comprises a control unit that controls to request the mobility management device to perform the verification of the user terminal before the base station determines to perform the handover to the specific cell.

A base station according to the third embodiment determines whether to perform handover of a user terminal to a specific cell in a mobile communication system including a home base station that forms a specific cell, a mobility management device that performs verification of the user terminal for access permission to the specific cell, and a gateway device that manages the home base station. The base station comprises a control unit that controls to notify the gateway device of information of each of the specific cell and the user terminal on the basis of a measurement report received from the user terminal before determining to perform the handover to the specific cell. The information notified by the control unit is used when the gateway device requests the mobility management device to perform the verification of the user terminal.

### First Embodiment

In the present embodiment, an example of a mobile communication system configured on the basis of 3GPP standards (that is, LTE-Advanced) after release 10 will be described.

Hereinafter, (1) Overview of mobile communication system, (2) Block configuration, (3) Operation, and (4) Conclusion of embodiment will be sequentially described.

### (1) Overview of Mobile Communication System

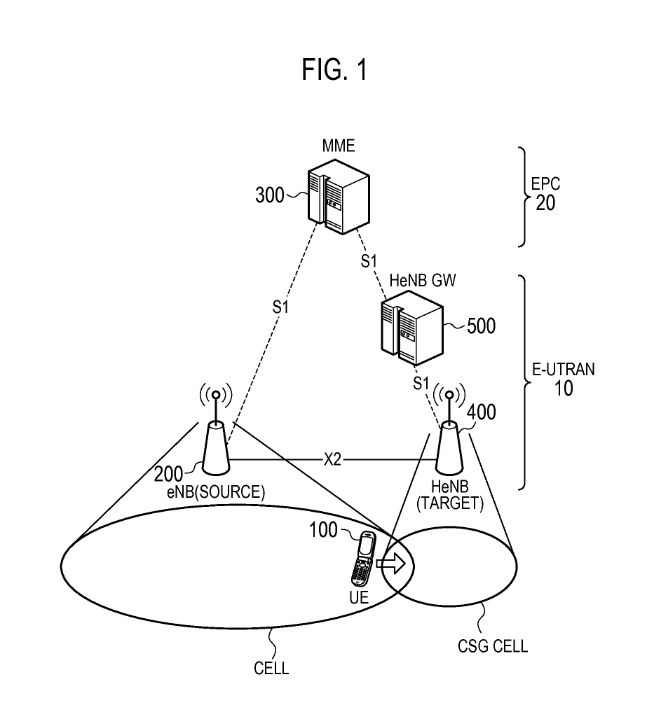

FIG. 1 is a configuration diagram of a mobile communication system according to the present embodiment. As illustrated in FIG. 1, the mobile communication system includes a user terminal (UE: User Equipment) 100, a base station (eNB: evolved Node-B) 200, a mobility management device (MME: Mobility Management Entity) 300, a home base station (HeNB: Home evolved Node-B) 400, and a gateway device (HeNB GW: Home evolved Node-B Gateway) 500.

Each of the eNB 200, the HeNB 400, and the HeNB GW 500 is a network device included in a radio access network (E-UTRAN: Evolved-UMTS Terrestrial Radio Access Network) 10. The MME 300 is a network device included in a core network (EPC: Evolved Packet Core) 20.

The UE 100 is a mobile radio communication device carried by a user. The UE 100 performs radio communication with a cell (called a “serving cell”), with which a connection is established, in a connected state corresponding to a state during communication.

When the UE 100 moves together with the movement of a user, a change in the serving cell of the UE 100 is necessary. An operation, in which the UE 100 changes the serving cell in an RRC connected state, is called “handover”. A series of procedures of the handover are called a “handover procedure”. The handover procedure includes a preparation stage (Preparation), an execution stage (Execution), and a completion stage (Completion).

In the present embodiment, the UE 100 employing a cell of the eNB 200 as a serving cell moves toward a cell of the HeNB 400, thereby performing handover from the cell of the eNB 200 to the cell of the HeNB 400. In this case, in the handover procedure, the cell of the eNB 200 is a “source cell” and the cell of the HeNB 400 is a “target cell”.

The eNB 200 is a macro base station (MeNB), a pico base station (PeNB), or a home base station (HeNB). In the present embodiment, a description will be provided for an example in which the eNB 200 is MeNB. The eNB 200 forms one cell or a plurality of cells. The eNB 200 performs radio communication with the UE 100.

The eNB 200 has a determination right of handover for the UE 100 subordinate to the cell of the eNB 200. Specifically, the eNB 200 is able to determine whether to perform handover of the UE 100 to a CSG cell on the basis of a measurement report from the UE 100.

The eNB 200 communicates with the EPC 20 through an S1 interface that is a logical communication path between the eNB 200 and the EPC 20. Specifically, the eNB 200 communicates with the MME 300 through an S1-MME interface which is a kind of the S1 interface. Moreover, the eNB 200 is able to perform inter-base station communication with an adjacent HeNB 400 through an X2 interface that is a logical communication path between the adjacent HeNB 400 and the eNB 200.

The MME 300 is provided corresponding to a control plane dealing with control information, and performs various types of mobility management or verification processes for the UE 100. The MME 300 performs the verification of the UE 100 for access permission to the CSG cell.

A general handover procedure to the CSG cell uses the S1 interface. Specifically, the MME 300 performs the verification of the UE 100, specifically, confirms whether the UE 100 is a member UE of the CSG cell. When it is confirmed that the UE 100 is the member UE of the CSG cell (that is, in the case of verification success), the handover of the UE 100 to the CSG cell is possible. On the other hand, when it is not confirmed that the UE 100 is the member UE of the CSG cell (that is, in the case of verification failure), the handover of the UE 100 to the CSG cell is rejected.

The HeNB 400 is a small stationary radio communication device installable within the house. The eNB 200 forms a specific cell having a coverage narrower than that of a cell. The specific cell is called a “CSG cell”, a “hybrid cell”, or an “open cell”, according to a set access mode.

The CSG cell is a cell accessible only by a UE 100 (called a “member UE”) having an access permission, and broadcasts CSG ID. The UE 100 holds a list (called a “white list”) of CSG ID for which the UE 100 has an access permission, and determines the presence or absence of access permission on the basis of the white list, and the CSG ID broadcasted by the CSG cell.

The hybrid cell is a cell in which the member UE is more advantageously treated as compared with a non-member UE, and broadcasts information, which indicates that the hybrid cell is a cell released to the non-member UE, in addition to the CSG ID. The UE 100 determines the presence or absence of access permission on the basis of the white list, and the CSG ID broadcasted by the hybrid cell.

As described above, the UE 100 confirms the presence or absence of access permission on the basis of the white list, but the white list may not be the latest one due to the delay of update. Therefore, the MME 300 performs the verification of the UE 100, so that the presence or absence of access permission is confirmed more reliably.

The open cell is a cell in which the UE 100 is equivalently treated regardless of whether the UE 100 is a member, and does not broadcast the CSG ID. In view of the UE 100, the open cell is equal to a cell.

In the present embodiment, a description will be provided for an example in which a cell (a specific cell) of the HeNB 400 is the CSG cell. However, the cell (the specific cell) of the HeNB 400 may be the hybrid cell.

The HeNB 400 communicates with the MME 300 via the HeNB GW 500 through the S1 interface (the S1-MME interface). However, when the S1 interface not via the HeNB GW 500 is established between the HeNB 400 and the MME 300, the HeNB 400 is able to also directly communicate with the MME 300 without via the HeNB GW 500.

The HeNB 400 is connected to the eNB 200 through the X2 interface. Hereinafter, a connection through the X2 interface will be referred to as an “X2 connection”.

The HeNB GW 500 manages a set of a plurality of HeNBs 400 between the EPC 20 (the MME 300) and the plurality of HeNBs 400. In view of the MME 300, the HeNB GW 500 is equal to the HeNB 400. On the other hand, in view of the HeNB 400, the HeNB GW 500 is equal to the MME 300. The HeNB GW 500 communicates with the MME 300 as a representative of the plurality of HeNBs 400, thereby reducing traffic to be transmitted to and received from the MME 300. Furthermore, the HeNB GW 500 is also able to relay data from one HeNB 400 managed by the HeNB GW 500 to another HeNB 400.

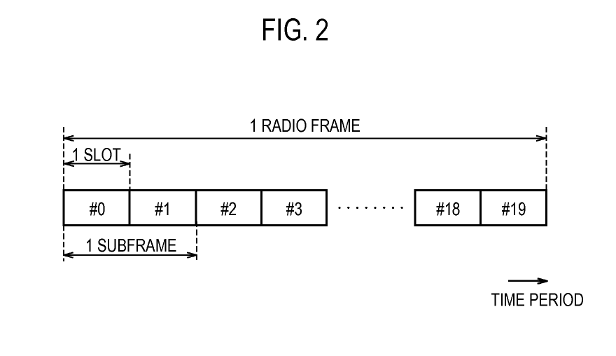

FIG. 2 is a configuration diagram of a radio frame used in the mobile communication system (an LTE system) according to the present embodiment. The LTE system employs OFDMA (Orthogonal Frequency Division Multiplexing Access) in a downlink and SC-FDMA (Single Carrier Frequency Division Multiple Access) in an uplink.

As illustrated in FIG. 2, the radio frame includes 10 subframes arranged in a time direction, wherein each subframe includes two slots arranged in the time direction. Each subframe has a length of 1 ms and each slot has a length of 0.5 ms. Each subframe includes a plurality of resource blocks (RBs) in a frequency direction, and a plurality of symbols in the time direction. Each symbol is provided at a head thereof with a guard interval called a cyclic prefix (CP).

In the downlink, an interval of several symbols at the head of each subframe is a control region mainly used as a physical downlink control channel (PDCCH). Furthermore, the other interval of each subframe is a data region mainly used as a physical downlink shared channel (PDSCH).

In the uplink, both end portions in the frequency direction of each subframe are control regions mainly used as a physical uplink control channel (PUCCH). Furthermore, the center portion in the frequency direction of each subframe is a data region mainly used as a physical uplink shared channel (PUSCH).

### (2) Block Configuration

Hereinafter, the block configurations of the UE 100, the eNB 200, the MME 300, the HeNB 400, and the HeNB GW 500 will be described.

(2.1) UE

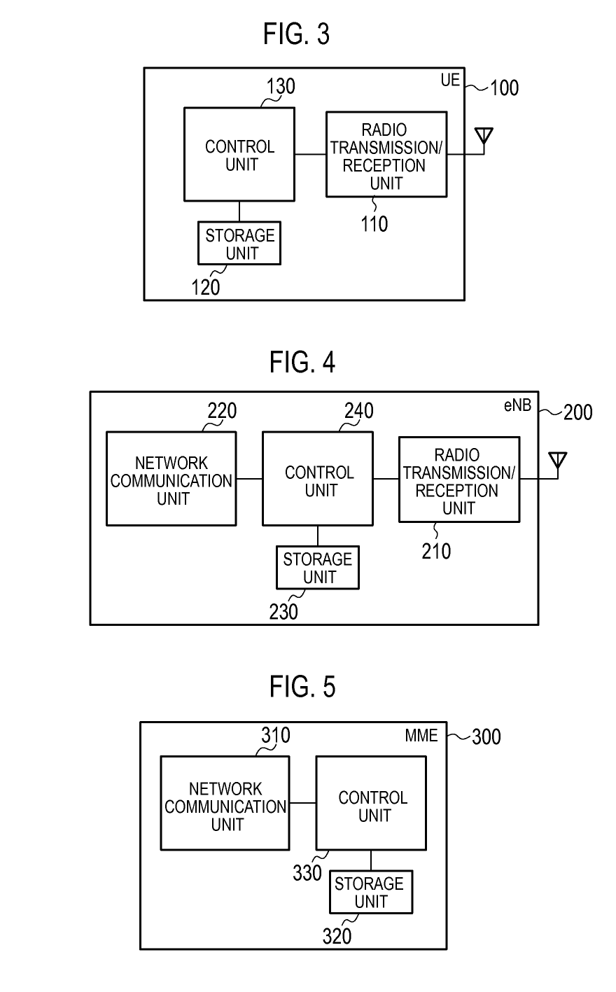

FIG. 3 is a block diagram of the UE 100. As illustrated in FIG. 3, the UE 100 includes a radio transmission/reception unit 110, a storage unit 120, and a control unit 130.

The radio transmission/reception unit 110 transmits/receives a radio signal.

The storage unit 120 stores various types of information that is used for the control by the control unit 130. The storage unit 120 stores a white list. Furthermore, the storage unit 120 stores location information (fingerprint information) on the location of a CSG cell for which the UE 100 has an access permission.

The control unit 130 controls various functions of the UE 100. In a connected state, the control unit 130 controls the radio transmission/reception unit 110 to perform radio communication with a serving cell.

When the UE 100 is in a connected state in the cell of the eNB 200, if it is detected that the UE 100 has entered the vicinity of the CSG cell, for which the UE 100 has an access permission, on the basis of the location information (the fingerprint information) on the location of the CSG cell for which the UE 100 has an access permission, the control unit 130 controls the radio transmission/reception unit 110 to transmit proximity notification (Proximity Indication) to the eNB 200.

When the radio transmission/reception unit 110 receives measurement control information (Measurement configuration) on the CSG cell from the eNB 200 in response to the proximity notification, the control unit 130 controls the radio transmission/reception unit 110 to transmit a measurement report including a physical identifier (PCI: Physical Cell Identifier) of the CSG cell to the eNB 200.

When the radio transmission/reception unit 110 receives request information (SI request) requesting the acquisition of broadcast information (SI: System Information) from the eNB 200 in response to the measurement report, the control unit 130 acquires broadcast information of the CSG cell and controls the radio transmission/reception unit 110 to transmit a measurement report including the broadcast information to the eNB 200. The measurement report includes an identifier (CGI: Cell Global Identifier) of the CSG cell, a tracking area identifier (TAII: Tracking Area Identifier), CSG ID, and status information (Membership status) indicating whether the UE 100 is a CSG member.

Then, when the radio transmission/reception unit 110 receives a handover command (H.O. command) to the CSG cell from the eNB 200, the control unit 130 starts a process of establishing a connection (RRC connection) to the CSG cell.

(2.2) eNB

FIG. 4 is a block diagram of the eNB 200. As illustrated in FIG. 4, the eNB 200 includes a radio transmission/reception unit 210, a network communication unit 220, a storage unit 230, and a control unit 240.

The radio transmission/reception unit 210 transmits/receives a radio signal. Furthermore, the radio transmission/reception unit 210 forms one cell or a plurality of cells.

The network communication unit 220 communicates with the MME 300 through the S1 interface. The network communication unit 220 performs inter-base station communication with the HeNB 400 through the X2 interface.

The storage unit 230 stores various types of information that is used for the control by the control unit 240.

The control unit 240 controls various functions of the eNB 200.

When the radio transmission/reception unit 210 receives the proximity notification (Proximity Indication) from the UE 100 subordinate to the eNB 200, the control unit 240 controls the radio transmission/reception unit 210 to transmit measurement control information (Measurement configuration) for instructing measurement for the CSG cell to the UE 100.

When the radio transmission/reception unit 210 receives the measurement report including the physical identifier (PCI: Physical Cell Identifier) of the CSG cell from the UE 100 in response to the measurement control information, the control unit 240 controls the radio transmission/reception unit 210 to transmit the request information (SI request) requesting the acquisition of broadcast information (SI: System Information) of the CSG cell to the UE 100.

When the radio transmission/reception unit 210 receives from the UE 100 the measurement report including the broadcast information of the CSG cell in response to the request information, the control unit 240 determines whether to perform handover of the UE 100 to the CSG cell on the basis of the measurement report.

In the present embodiment, before it is determined to perform the handover to the CSG cell, the control unit 240 controls the network communication unit 220 to request the MME 300 to perform verification (pre-verification) of the UE 100. Specifically, the control unit 240 controls the network communication unit 310 to transmit a verification request (CSG verification request) of the UE 100 to the MME 300. The verification request includes the CSD ID of the CSG cell and the identification information of the UE 100.

When the network communication unit 220 receives verification results (CSG verification Ack/Nack) from the MME 300 in response to the verification request, the control unit 330 controls the storage unit 230 to store (hold) the verification results.

The control unit 330 uses the results of the pre-verification obtained in this way in the handover procedure to the CSG cell. Details of the handover procedure will be described later.

(2.3) MME

FIG. 5 is a block diagram of the MME 300. As illustrated in FIG. 5, the MME 300 includes a network communication unit 310, a storage unit 320, and a control unit 330.

The network communication unit 310 communicates with the eNB 200 and the HeNB GW 500 through the S1 interface.

The storage unit 320 stores various types of information that is used for the control by the control unit 330. The storage unit 320 stores CSG subscriber information (CSG Subscription Data) regarding the access permission of the UE 100. The CSG subscriber information is obtained by associating the identifier of the UE 100 with CSD ID of each CSG cell for which the UE 100 has an access permission.

The control unit 330 controls various functions of the MME 300.

When the network communication unit 310 receives the verification request (CSG verification request) of the UE 100, the control unit 330 performs verification of the UE 100 on the basis of the CSD ID and the identification information of the UE 100, which are included in the verification request, and the CSG subscriber information stored in the storage unit 320.

When the CSD ID and the identification information of the UE 100, which are included in the verification request, are associated with the CSG subscriber information, the control unit 330 determines verification success and controls the network communication unit 310 to transmit a response (CSG verification Ack) indicating the verification success.

Meanwhile, when the CSD ID and the identification information of the UE 100, which are included in the verification request, are not associated with the CSG subscriber information, the control unit 330 determines verification failure and controls the network communication unit 310 to transmit a response (CSG verification Nack) indicating the verification failure.

(2.4) HeNB

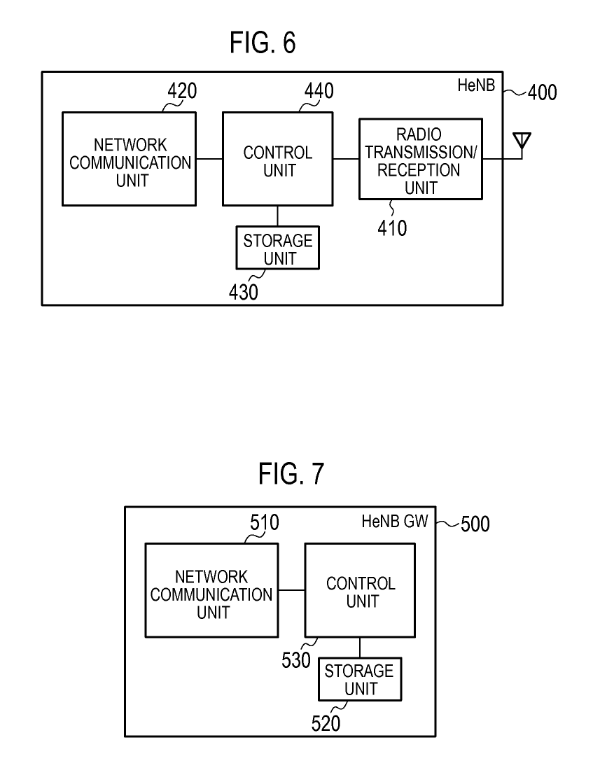

FIG. 6 is a block diagram of the HeNB 400. As illustrated in FIG. 6, the HeNB 400 includes a radio transmission/reception unit 410, a network communication unit 420, a storage unit 430, and a control unit 440.

The radio transmission/reception unit 410 transmits/receives a radio signal. In the present embodiment, the radio transmission/reception unit 410 forms the CSG cell.

The network communication unit 420 communicates with the MME 300 via the HeNB GW 500 through the S1 interface. The network communication unit 220 performs inter-base station communication with the eNB 200 through the X2 interface.

The storage unit 430 stores various types of information that is used for the control by the control unit 440.

The control unit 440 controls various functions of the HeNB 400. The control unit 440 performs control according to the handover procedure to the CSG cell. Details of the handover procedure will be described later.

(2.5) HeNB GW

FIG. 7 is a block diagram of the HeNB GW 500. As illustrated in FIG. 7, the HeNB GW 500 includes a network communication unit 510, a storage unit 520, and a control unit 530.

The network communication unit 510 communicates with the MME 300 and the HeNB 400 through the S1 interface.

The storage unit 520 stores various types of information that is used for the control by the control unit 530. In the storage unit 520, the HeNB 400 managed by the HeNB GW 500 has been registered.

The control unit 530 controls various functions of the HeNB GW 500. The control unit 530 manages a set of a plurality of HeNBs 400. The control unit 530 controls the network communication unit 510 to communicate with the MME 300 as a representative of the plurality of HeNBs 400.

### (3) Operation

Hereinafter, the operation of the mobile communication system according to the present embodiment will be described.

(3.1) Pre-Verification Determination Process in eNB

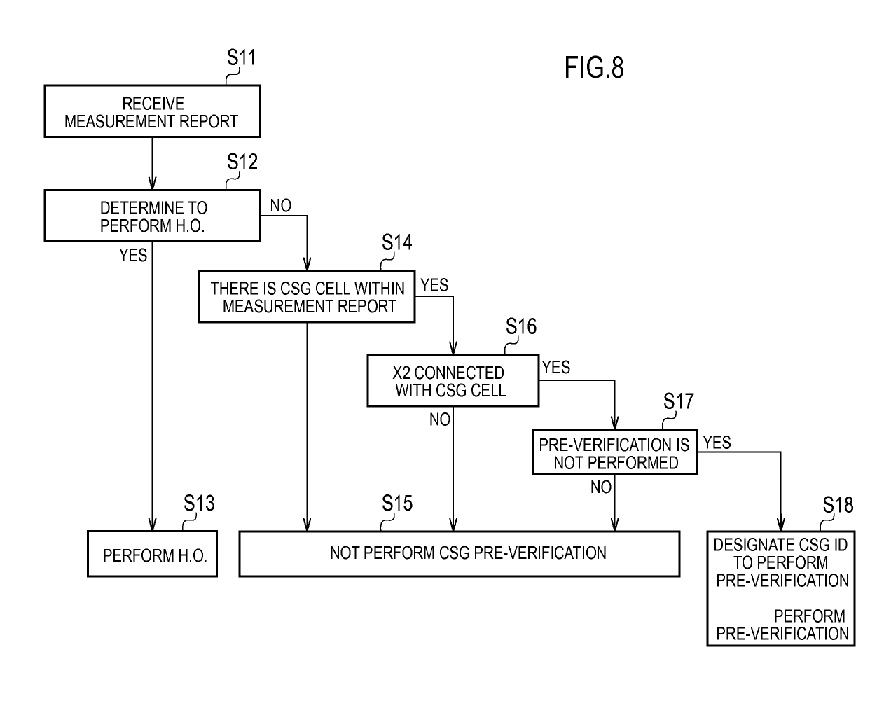

FIG. 8 is a flowchart of a pre-verification determination process in the eNB 200.

As illustrated in FIG. 8, in step S11, the eNB 200 receives a measurement report (Measurement Report) from the UE 100.

In step S12, the eNB 200 determines whether to perform handover of the UE 100 on the basis of the measurement report from the UE 100. When it is determined to perform the handover of the UE 100 (step S12; YES), the eNB 200 performs the handover of the UE 100 in step S13.

When it is determined not to perform the handover of the UE 100 (step S12; NO), the eNB 200 confirms whether the ID of the CSG cell (the CSG ID) is included in the measurement report from the UE 100 in step S14. When the ID of the CSG cell is not included in the measurement report from the UE 100 (step S14; NO), the eNB 200 does not perform the pre-verification of the UE 100 (step S15).

When the ID of the CSG cell is included in the measurement report from the UE 100 (step S14; YES), the eNB 200 confirms whether to have the X2 connection to the HeNB 400 forming the CSG cell in step S16. When the eNB 200 has no X2 connection to the HeNB 400 forming the CSG cell (step S16; NO), the eNB 200 does not perform the pre-verification of the UE 100 (step S15).

When the eNB 200 has the X2 connection to the HeNB 400 forming the CSG cell (step S16; YES), the eNB 200 confirms whether the pre-verification of the UE 100 has not been performed, in step S17. When the pre-verification of the UE 100 has been already performed (step S17; NO), the eNB 200 does not perform the pre-verification of the UE 100 (step S15).

When the pre-verification of the UE 100 has not been performed (step S17; YES), the eNB 200 designates CSG ID by which the pre-verification is to be performed, and transmits the verification request (CSG verification request) of the UE 100 to the MME 300 in step S18.

(3.2) Operation Sequence 1

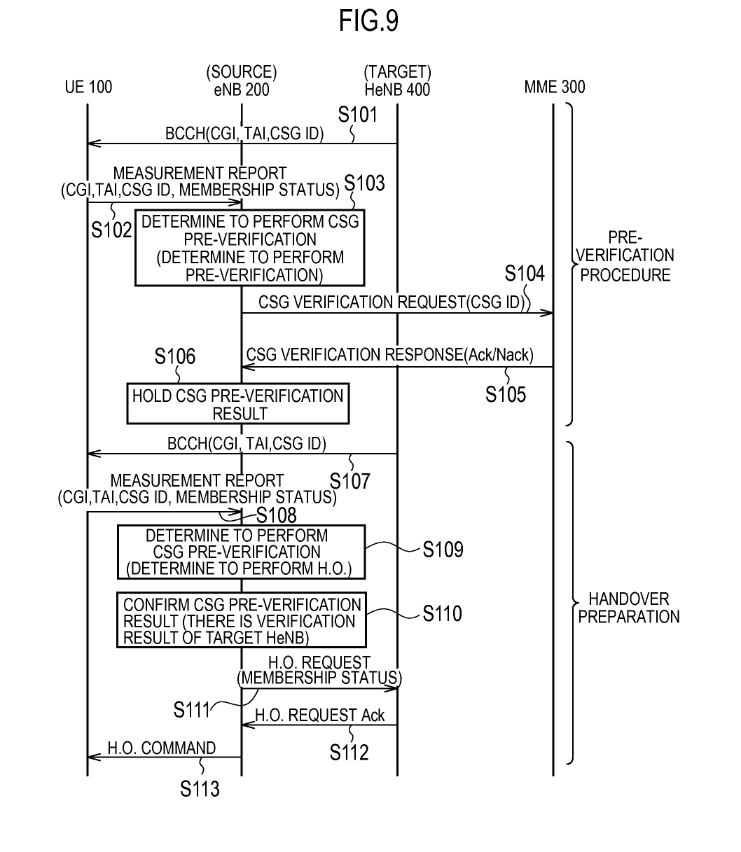

Next, an operation sequence 1 of the mobile communication system will be described. FIG. 9 is a sequence diagram of the operation sequence 1.

As illustrated in FIG. 9, in step S101, the UE 100 receives broadcast information from the HeNB 400 through BCCH (Broadcast Control Channel). The broadcast information includes CGI, TAI, and CSG ID.

In step S102, the UE 100 transmits a measurement report including the CGI, the TAI, the CSG ID, and Membership status to the eNB 200.

In step S103, the eNB 200 determines to perform pre-verification according to the flow of FIG. 8.

In step S104, the eNB 200 transmits the verification request (CSG verification request) of the UE 100 to the MME 300 through the S1 interface. The verification request includes the CSD ID of the CSG cell and the identification information of the UE 100.

In step S105, the MME 300 transmits a response (CSG verification response) indicating a verification result to the eNB 200 through the S1 interface. Hereinafter, a description will be given on the assumption that the response indicates verification success (Ack).

In step S106, the eNB 200 receives the response from the MME 300 and stores a result of the verification by the MME 300.

In step S107, the UE 100 receives the broadcast information from the HeNB 400 through the BCCH. The broadcast information includes CGI, TAI, and CSG ID.

In step S108, the UE 100 transmits the measurement report including the CGI, the TAI, the CSG ID, and the Membership status to the eNB 200.

In step S109, the eNB 200 determines to perform the handover of the UE 100 to the CSG cell according to the flow of FIG. 8. From the time point at which it is determined to perform the handover of the UE 100, a preparation stage (Preparation) in the handover procedure is started.

In step S110, the eNB 200 confirms that the verification result stored in step S106 indicates the verification success (Ack).

In step S111, the eNB 200 transmits a handover request (H.O. Request) for requesting acceptance of the UE 100 to the HeNB 400 through the X2 interface. The handover request includes the Membership status.

In this way, when it is determined to perform the handover to the CSG cell on the basis of the measurement report from the UE 100 and the verification result indicating the verification success (Ack) is obtained from the MME 300, the eNB 200 transmits the handover request to the HeNB 400.

When the handover request is received from the eNB 200 through the X2 interface, the HeNB 400 determines whether to permit the handover request on the basis of the handover request. Hereinafter, a description will be given on the assumption that the handover request is permitted.

In step S112, the HeNB 400 transmits a positive response (H.O. Request Ack) for the handover request to the eNB 200 through the X2 interface.

In step S113, the eNB 200 transmits a command of the handover (H.O. Command) to the CSG cell to the UE 100 in response to the reception of the positive response from the HeNB 400.

(3.3) Operation Sequence 2

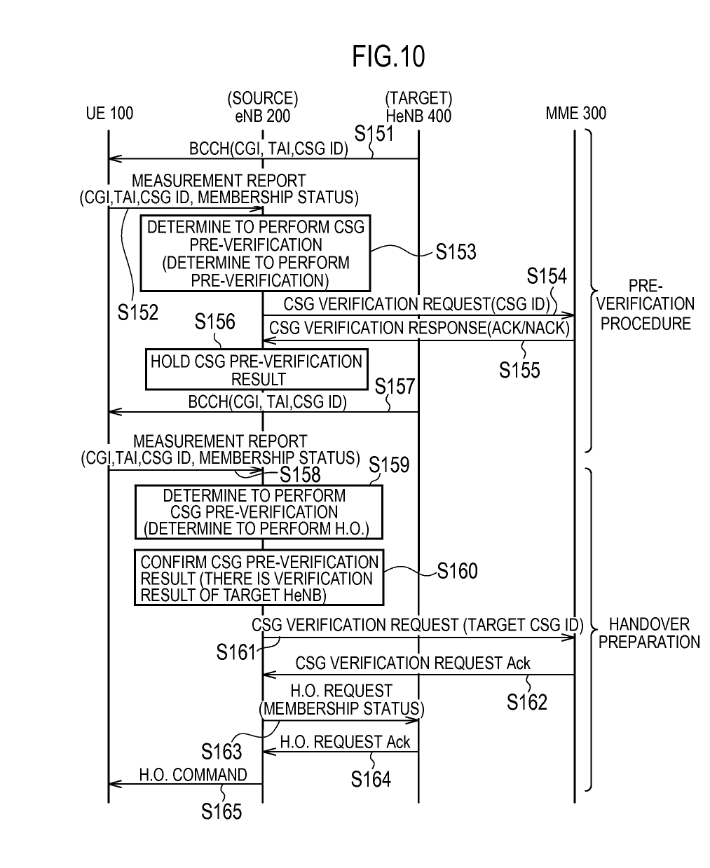

Next, an operation sequence 2 of the mobile communication system will be described. The present sequence is a sequence equal to the operation pattern 1, but the case, in which it is determined to perform the handover to the CSG cell before the pre-verification is performed, will be described. FIG. 10 is a sequence diagram of the operation sequence 2.

As illustrated in FIG. 10, in the operation sequence 2, step S151 to step S156 are not performed, and it is determined to perform the handover to the CSG cell. Thus, operations after step S157 will be described.

In step S157, the UE 100 receives broadcast information from the HeNB 400 through BCCH. The broadcast information includes CGI, TAI, and CSG ID.

In step S158, the UE 100 transmits a measurement report including the CGI, the TAI, the CSG ID, and Membership status to the eNB 200.

In step S159, the eNB 200 determines to perform the handover of the UE 100 to the CSG cell according to the flow of FIG. 8.

In step S160, the eNB 200 confirms that pre-verification has not been performed.

In step S161, the eNB 200 transmits the verification request (CSG verification request) of the UE 100 to the MME 300 through the S1 interface. The verification request includes the CSD ID of the CSG cell and the identification information of the UE 100.

In this way, in the operation sequence 2, when it is determined to perform the handover to the CSG cell on the basis of the measurement report from the UE 100 and a verification result indicating verification success is not obtained from the MME 300, the eNB 200 requests the MME 300 to perform the verification of the UE 100.

In step S162, the MME 300 transmits a response (CSG verification response) indicating the verification result to the eNB 200 through the S1 interface. Hereinafter, a description will be given on the assumption that the response indicates verification success (Ack).

In step S163, the eNB 200 transmits a handover request (H.O. Request) for requesting acceptance of the UE 100 to the HeNB 400 through the X2 interface in response to the verification success (Ack). The handover request includes the Membership status.

When the handover request is received from the eNB 200 through the X2 interface, the HeNB 400 determines whether to permit the handover request on the basis of the handover request. Hereinafter, a description will be given on the assumption that the handover request is permitted.

In step S164, the HeNB 400 transmits a positive response (H.O. Request Ack) for the handover request to the eNB 200 through the X2 interface.

In step S165, the eNB 200 transmits a command of the handover (H.O. Command) to the CSG cell to the UE 100 in response to the reception of the positive response from the HeNB 400.

(3.4) Operation Sequence 3

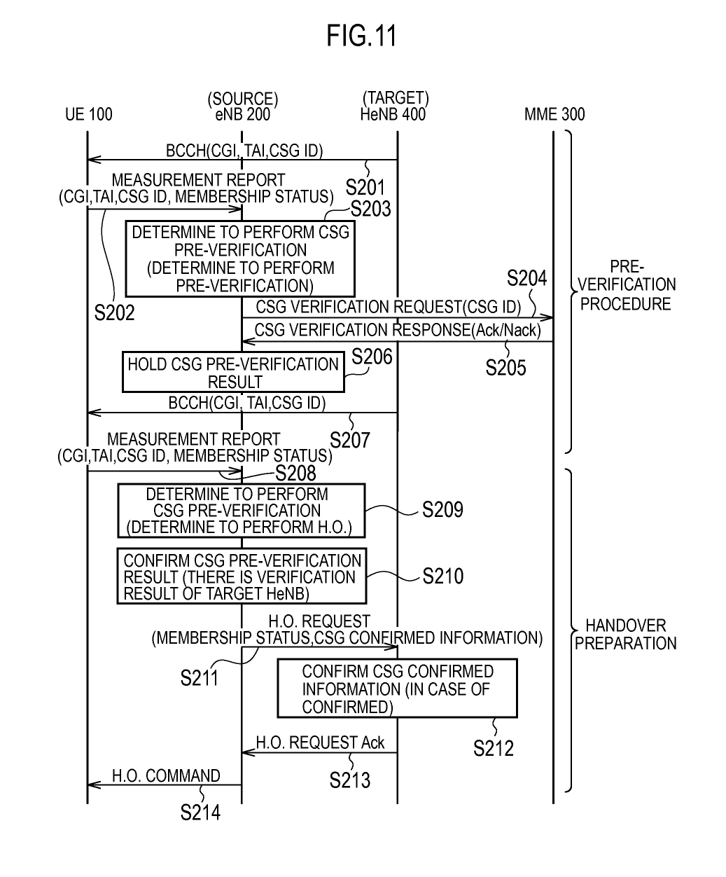

Next, an operation sequence 3 of the mobile communication system will be described. In the present sequence, differently from the operation patterns 1 and 2, the verification result is transmitted to the HeNB 400 together with the handover request and the HeNB 400 determines whether to permit the handover request on the basis of the verification result. FIG. 11 is a sequence diagram of the operation sequence 3.

As illustrated in FIG. 11, in step S201, the UE 100 receives broadcast information from the HeNB 400 through BCCH. The broadcast information includes CGI, TAI, and CSG ID.

In step S202, the UE 100 transmits a measurement report including the CGI, the TAI, the CSG ID, and Membership status to the eNB 200.

In step S203, the eNB 200 determines to perform pre-verification according to the flow of FIG. 8.

In step S204, the eNB 200 transmits the verification request (CSG verification request) of the UE 100 to the MME 300 through the S1 interface. The verification request includes the CSG ID of the CSG cell and the identification information of the UE 100.

In step S205, the MME 300 transmits a response (CSG verification response) indicating a verification result to the eNB 200 through the S1 interface.

In step S206, the eNB 200 receives the response from the MME 300 and stores a result of the verification by the MME 300.

In step S207, the UE 100 receives the broadcast information from the HeNB 400 through the BCCH. The broadcast information includes CGI, TAI, and CSG ID.

In step S208, the UE 100 transmits the measurement report including the CGI, the TAI, the CSG ID, and the Membership status to the eNB 200.

In step S209, the eNB 200 determines to perform the handover of the UE 100 to the CSG cell according to the flow of FIG. 8.

In step S210, the eNB 200 confirms that the verification result is stored in step S206.

In step S211, the eNB 200 transmits a handover request (H.O. Request) for requesting acceptance of the UE 100 to the HeNB 400 through the X2 interface. The handover request includes the Membership status, and information (CSG Confirmed Information) on the verification result from the MME 300. The information on the verification result, for example, indicates whether a verification result indicating verification success (Ack) is obtained (Confirmed).

In this way, when it is determined to perform the handover to the CSG cell on the basis of the measurement report from the UE 100, the eNB 200 transmits the information on the verification result from the MME 300 to the HeNB 400 together with the handover request.

In step S212, the HeNB 400 determines whether to permit the handover request on the basis of the handover request from the eNB 200. Specifically, the HeNB 400 permits the handover request from the eNB 200 in response to the fact that the information on the verification result from the eNB 200 indicates the verification success (Confirmed). Hereinafter, a description will be given on the assumption that the handover request is permitted.

In step S213, the HeNB 400 transmits a positive response (H.O. Request Ack) for the handover request to the eNB 200 through the X2 interface.

In step S214, the eNB 200 transmits a command of the handover (H.O. Command) to the CSG cell to the UE 100 in response to the reception of the positive response from the HeNB 400.

(3.5) Operation Sequence 4

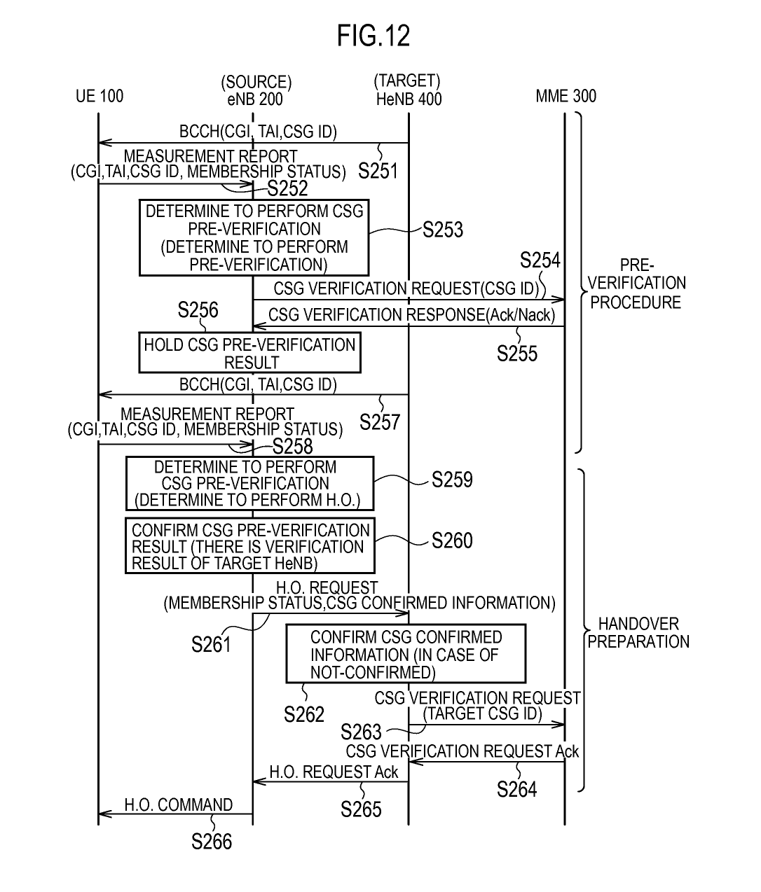

Next, an operation sequence 4 of the mobile communication system will be described. The present sequence is a sequence equal to the operation pattern 3, but the case, in which it is determined to perform the handover to the CSG cell before the pre-verification is performed, will be described. FIG. 12 is a sequence diagram of the operation sequence 4.

As illustrated in FIG. 12, in the operation sequence 4, step S251 to step S256 are not performed, and it is determined to perform the handover to the CSG cell. Thus, operations after step S257 will be described.

In step S257, the UE 100 receives broadcast information from the HeNB 400 through BCCH. The broadcast information includes CGI, TAI, and CSG ID.

In step S258, the UE 100 transmits a measurement report including the CGI, the TAI, the CSG ID, and Membership status to the eNB 200.

In step S259, the eNB 200 determines to perform the handover of the UE 100 to the CSG cell according to the flow of FIG. 8.

In step S260, the eNB 200 confirms that pre-verification has not been performed.

In step S261, the eNB 200 transmits a handover request (H.O. Request) for requesting acceptance of the UE 100 to the HeNB 400 through the X2 interface. The handover request includes the Membership status, and information (CSG Confirmed Information) on the verification result from the MME 300. The information on the verification result, for example, indicates whether a verification result indicating verification success (Ack) is obtained (Confirmed).

In step S262, the HeNB 400 determines whether to permit the handover request on the basis of the handover request from the eNB 200. Specifically, the HeNB 400 permits the handover request from the eNB 200 in response to the fact that the information on the verification result from the eNB 200 indicates the verification success (Confirmed). Hereinafter, a description will be given on the assumption that the information on the verification result from the eNB 200 does not indicate the verification success (Confirmed).

In step S263, the HeNB 400 transmits a verification request (CSG verification request) of the UE 100 to the MME 300 through the S1 interface. The verification request includes the CSD ID of the CSG cell and the identification information of the UE 100.

In step S264, the MME 300 transmits a response (CSG verification response) indicating a verification result to the HeNB 400 through the S1 interface. Hereinafter, a description will be given on the assumption that the response indicates verification success (Ack).

In step S265, the HeNB 400 transmits a positive response (H.O. Request Ack) for the handover request to the eNB 200 through the X2 interface in response to the verification success (Ack).

In step S266, the eNB 200 transmits a command of the handover (H.O. Command) to the CSG cell to the UE 100 in response to the reception of the positive response from the HeNB 400.

### (4) Conclusion of Embodiment

As described above, in the mobile communication system including the HeNB 400 configured to form the CSG cell, the eNB 200 configured to determine whether to perform the handover of the UE 100 to the CSG cell, and the MME 300 configured to perform the verification of the UE 100 for access permission to the CSG cell, the eNB 200 requests the MME 300 to perform the verification of the UE 100 before determining to perform the handover to the CSG cell.

In this way, the MME 300 performs the verification (that is, the pre-verification) of the UE 100 at a stage before the handover procedure, so that it is possible to omit the verification of the UE 100 by the MME 300 in the course of the handover procedure. Furthermore, in the handover procedure, it is possible to transmit the handover request from the eNB 200 to the HeNB 400, bypassing the MME 300, resulting in the reduction of signaling to the MME 300.

In the present embodiment, the eNB 200 holds the verification result obtained from the MME 300. Then, when it is determined to perform the handover to the CSG cell on the basis of the measurement report from the UE 100 and the verification result indicating the verification success is obtained from the MME 300, the eNB 200 transmits the handover request to the HeNB 400.

In this way, when it is determined to perform the handover to the CSG cell, if the verification result indicating the verification success is obtained from the MME 300 through the pre-verification, the handover request is directly (that is, through the X2 interface) transmitted to the HeNB 400, so that it is possible to quickly perform the handover to the CSG cell.

In the present embodiment, when it is determined to perform the handover to the CSG cell on the basis of the measurement report from the UE 100 and the verification result indicating the verification success is not obtained from the MME 300, the eNB 200 requests the MME 300 to perform the verification of the UE 100.

In this way, when it is determined to perform the handover to the CSG cell, if the verification result indicating the verification success is not obtained from the MME 300 through the pre-verification, the eNB 200 requests the MME 300 to perform the verification of the UE 100, so that the handover to the CSG cell is possible.

In the present embodiment, when it is determined to perform the handover to the CSG cell on the basis of the measurement report from the UE 100, the eNB 200 transmits the information on the verification result from the MME 300 to the HeNB 400 together with the handover request.

In this way, the information on the verification result from the MME 300 is transmitted to the HeNB 400 together with the handover request, so that the HeNB 400 is able to determine to permit the handover request on the basis of the information on the verification result.

In the present embodiment, the HeNB 400 permits the handover request from the eNB 200 in response to the fact that the information on the verification result from the eNB 200 indicates the verification success.

In this way, the HeNB 400 confirms the validity of the UE 100, thereby permitting the handover request from the eNB 200.

In the present embodiment, the HeNB 400 requests the MME 300 to perform the verification of the UE 100 in response to the fact that the information on the verification result from the eNB 200 indicates the verification failure.

In this way, if it is not possible to confirm the validity of the UE 100, the HeNB 400 requests the MME 300 to perform the verification of the UE 100, so that the handover to the CSG cell is possible.

### Second Embodiment

Next, the mobile communication system according to a second embodiment will be described. In addition, portions different from the above-described first embodiment are mainly described and portions similar to the first embodiment are appropriately omitted.

In the above-described first embodiment, the eNB 200 requests the MME 300 to perform the verification of the UE 100, but in the present embodiment, the HeNB 400 requests the MME 300 to perform the verification of the UE 100.

Hereinafter, (1) Block configuration, (2) Operation, and (3) Conclusion of embodiment will be sequentially described.

### (1) Block Configuration

Hereinafter, the block configurations of the eNB 200, the MME 300, and the HeNB 400 according to the present embodiment will be described.

(1.1) eNB

In the present embodiment, before determining to perform the handover to the CSG cell, the control unit 240 notifies the HeNB 400 of information of each of the CSG cell and the UE 100 on the basis of the measurement report received from the UE 100. Specifically, the control unit 240 controls the network communication unit 220 to transmit a terminal verification message including the information of each of the CSG cell and the UE 100 to the HeNB 400 through the X2 interface. Furthermore, the information of the CSG cell, for example, includes an access mode (CSG/hybrid) and CSG ID. Furthermore, the information of the UE 100 includes identification information of the UE 100, and for example, includes RNTI (Radio Network Temporary ID).

Furthermore, when it is determined to perform the handover to the CSG cell, the control unit 240 controls the network communication unit 220 to transmit a handover request to the HeNB 400 through the X2 interface. Then, when the network communication unit 220 has received a positive response (HO Request Ack) for the handover request from the HeNB 400, the control unit 240 controls the radio transmission/reception unit 210 to transmit a command of the handover (HO Command) to the CSG cell to the UE 100.

(1.2) MME

In the present embodiment, when the network communication unit 310 receives a terminal verification request message from the HeNB 400 through the S1 interface, the control unit 330 performs verification of the UE 100 on the basis of CSD ID, the access mode, and the identification information of the UE 100, which are included in the terminal verification request message, and the CSG subscriber information stored in the storage unit 320.

When the CSG ID and the identification information of the UE 100, which are included in the terminal verification request message, are associated with the CSG subscriber information, the control unit 330 determines verification success and controls the network communication unit 310 to transmit a terminal verification response indicating the verification success to the HeNB 400 through the S1 interface. The terminal verification response includes the CSG ID, and status information (Membership status) indicating whether the UE 100 is a CSG member.

In addition, when the CSG ID and the identification information of the UE 100, which are included in the terminal verification request message, are not associated with the CSG subscriber information, the control unit 330 determines verification failure and controls the network communication unit 310 to transmit a terminal verification response indicating the verification failure.

(1.3) HeNB

In the present embodiment, when the network communication unit 420 receives the terminal verification message from the eNB 200 through the X2 interface, the control unit 440 controls the network communication unit 420 to transmit the aforementioned terminal verification request message to the MME 300 through the S1 interface on the basis of the terminal verification message.

When the network communication unit 420 receives a terminal verification response indicating a verification result from the MME 300 through the S1 interface in response to the terminal verification message, the control unit 440 controls the storage unit 430 to hold the verification result.

Then, when the network communication unit 420 receives a handover request from the eNB 200 through the X2 interface, the control unit 440 determines whether to permit the handover request on the basis of the verification result held in the storage unit 430.

When determining to permit the handover request, the control unit 440 controls the network communication unit 420 to transmit a positive response (HO Request Ack) for the handover request to the eNB 200 through the X2 interface.

Meanwhile, when determining to reject the handover request, the control unit 440 controls the network communication unit 420 to transmit a negative response (HO Request Nack) for the handover request to the eNB 200 through the X2 interface.

### (2) Operation

Hereinafter, the operation of the mobile communication system according to the present embodiment will be described.

(2.1) Operation Sequence

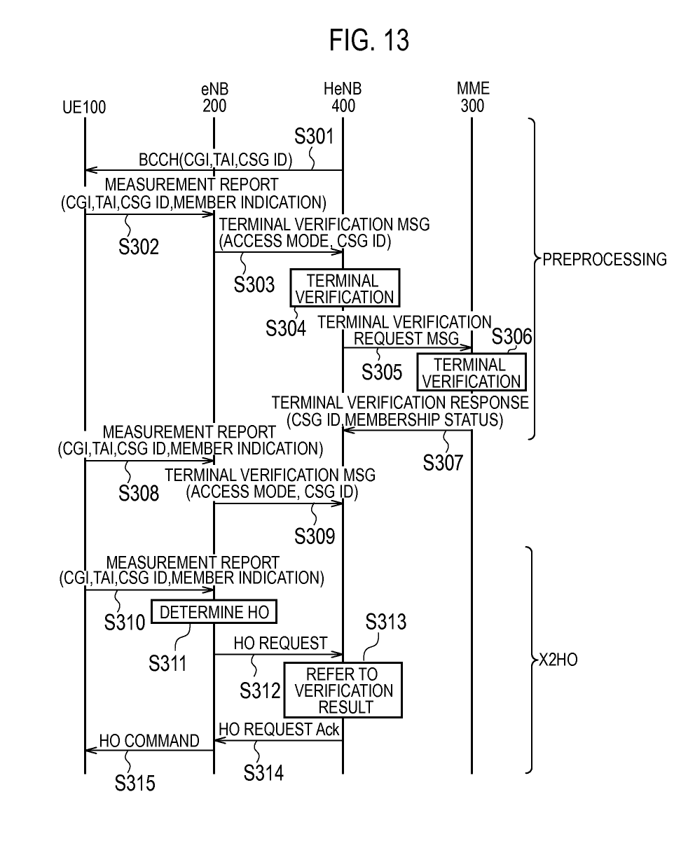

FIG. 13 is an operation sequence diagram of the mobile communication system according to the present embodiment. In the present sequence, a description will be provided for an operation when the UE 100 periodically transmits a measurement report.

As illustrated in FIG. 13, in Step 301, the UE 100 receives broadcast information from the HeNB 400 through BCCH (Broadcast Control Channel). The broadcast information includes CGI, TAI, and CSG ID.

In Step 302, the UE 100 transmits a measurement report including the CGI, the TAI, the CSG ID, and Member Indication to the eNB 200.

In Step 303, the eNB 200 determines whether to perform handover of the UE 100 to the CSG cell on the basis of the measurement report from the UE 100. Hereafter, a description will be given on the assumption that the eNB 200 determines not to perform the handover of the UE 100 to the CSG cell. The eNB 200 transmits a terminal verification message to the HeNB 400 through the X2 interface on the basis of the measurement report from the UE 100. The terminal verification message includes CSG ID and an access mode. Furthermore, the terminal verification message includes identification information of the UE 100.

In Step 304, the HeNB 400 performs verification of the UE 100 on the basis of the terminal verification message from the eNB 200. For example, the HeNB 400 confirms whether the CSG ID included in the terminal verification message coincides with CSG ID of a CSG cell of the HeNB 400. Hereafter, a description will be given on the assumption that the verification is succeeded.

In Step 305, the HeNB 400 transmits a terminal verification request message to the MME 300 through the S1 interface on the basis of the terminal verification message from the eNB 200. The terminal verification request message includes the CSD ID, the access mode, and the identification information of the UE 100.

In Step 306, the MME 300 performs pre-verification of the UE 100, that is, confirms whether the UE 100 is a member UE on the basis of the CSD ID, the access mode, and the identification information of the UE 100, which are included in the terminal verification request message from the HeNB 400, and CSG subscriber information stored in advance.

In Step 307, the MME 300 transmits a terminal verification response indicating a verification result in Step 306 to the HeNB 400 through the S1 interface. The terminal verification response includes the CSG ID, and status information (Membership status) indicating whether the UE 100 is a CSG member. When the terminal verification response is received from the MME 300, the HeNB 400 holds the terminal verification response as the verification result of the pre-verification.

In Step 308, the UE 100 transmits the measurement report including the CGI, the TAI, the CSG ID, and the Member Indication to the eNB 200.

In Step 309, the eNB 200 determines whether to perform the handover of the UE 100 to the CSG cell on the basis of the measurement report from the UE 100. Hereafter, a description will be given on the assumption that the eNB 200 determines not to perform the handover of the UE 100 to the CSG cell. The eNB 200 transmits a terminal verification message to the HeNB 400 through the X2 interface on the basis of the measurement report from the UE 100. The terminal verification message includes CSG ID and an access mode. Furthermore, the terminal verification message includes identification information of the UE 100.

When the terminal verification message is received from the eNB 200, the HeNB 400 ignores the terminal verification message because the HeNB 400 already has held the pre-verification result.

In Step 310, the UE 100 transmits the measurement report including the CGI, the TAI, the CSG ID, and the Member Indication to the eNB 200.

In Step 311, the eNB 200 determines whether to perform the handover of the UE 100 to the CSG cell on the basis of the measurement report from the UE 100. Hereafter, a description will be given on the assumption that the eNB 200 determines to perform the handover of the UE 100 to the CSG cell. From the time point at which the eNB 200 determines to perform the handover, a preparation stage (HO Preparation) in the handover procedure is started.

In Step 312, the eNB 200 transmits a handover request (HO Request) for requesting acceptance of the UE 100 to the HeNB 400 through the X2 interface.

In Step 313, the HeNB 400 determines whether to permit the handover request from the eNB 200 with reference to the pre-verification result obtained in Step 307. Specifically, the HeNB 400 determines to permit the handover request when the pre-verification result obtained in Step 307 indicates verification success. The HeNB 400 determines to reject the handover request when the pre-verification result obtained in Step 307 indicates verification failure. Hereafter, a description will be given on the assumption that the HeNB 400 determines to permit the handover request.

In Step 314, the HeNB 400 transmits, to the eNB 200, a positive response (HO Request Ack) for the handover request from the eNB 200 through the X2 interface.

In Step 315, the eNB 200 transmits a command of the handover (HO Command) to the CSG cell to the UE 100 in response to the positive response (HO Request Ack) from the HeNB 400.

(2.2) Operation of HeNB

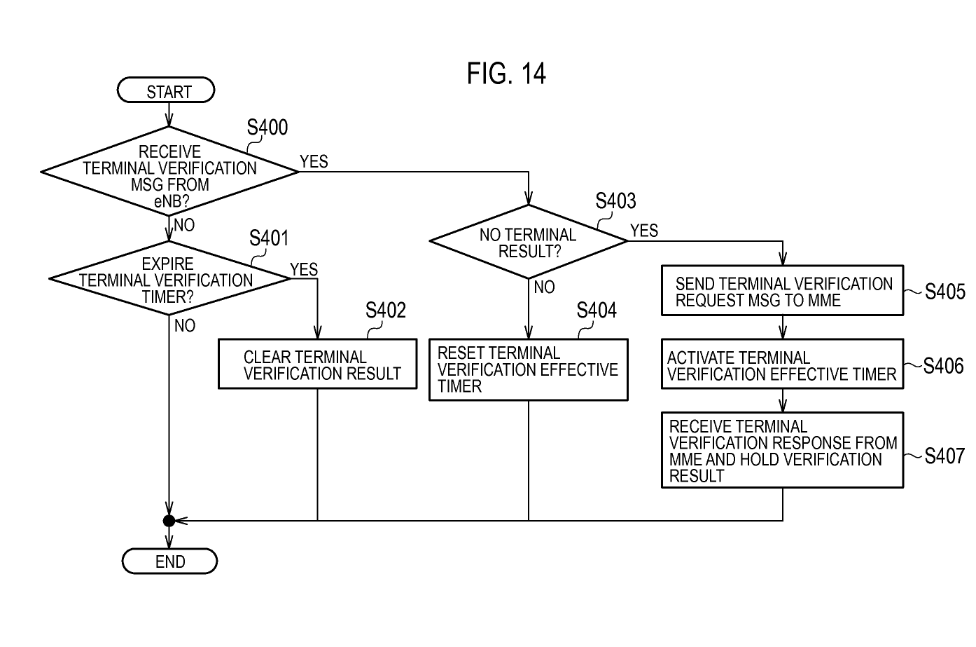

FIG. 14 is an operation flowchart of the HeNB 400. In the present flow, the HeNB 400 manages a pre-verification result using a terminal verification timer.

As illustrated in FIG. 14, in step S400, the HeNB 400 confirms whether a terminal verification message has been received from the eNB 200.

When the terminal verification message is not received from the eNB 200 (step S400; No), the HeNB 400 confirms whether the terminal verification timer has expired in step S401. When the terminal verification timer has expired (step S401; Yes), the HeNB 400 discards (clears) the held pre-verification result in step S402.

Meanwhile, when the terminal verification message has been received from the eNB 200 (step S400; Yes), the HeNB 400 confirms whether the pre-verification result has been held in step S403. When pre-verification has not been performed or when the pre-verification has already been performed but the pre-verification result has been discarded due to time-out, it is regarded that the HeNB 400 has not held the pre-verification result.

When the pre-verification result has been held (step S403; No), the HeNB 400 resets the terminal verification timer in step S404.

On the other hand, when the pre-verification result has not been held (step S403; Yes), the HeNB 400 transmits the aforementioned terminal verification request message to the MME 300 in step S405. Then, the HeNB 400 activates the terminal verification timer (step S406), and receives and holds the pre-verification result from the MME 300 (step S407).

### (3) Conclusion of Embodiment

As described above, in the mobile communication system including the HeNB 400 configured to form the CSG cell, the eNB 200 configured to determine whether to perform the handover of the UE 100 to the CSG cell, and the MME 300 configured to perform the verification of the UE 100 for access permission to the CSG cell, the HeNB 400 requests the MME 300 to perform the verification of the UE 100 before the eNB 200 determines to perform the handover to the CSG cell.

In this way, the MME 300 performs the verification (that is, the pre-verification) of the UE 100 at a stage before the handover procedure, so that it is possible to omit the verification of the UE 100 by the MME 300 in the course of the handover procedure. Furthermore, in the handover procedure, it is possible to ensure that the MME 300 does not intervene, resulting in the reduction of signaling to the MME 300.

In the present embodiment, before determining to perform the handover to the CSG cell, the eNB 200 notifies the HeNB 400 of information of each of the CSG cell and the UE 100 on the basis of the measurement report received from the UE 100. The HeNB 400 requests the MME 300 to perform the verification of the UE 100 on the basis of the information notified from the eNB 200.

In this way, at a stage before the handover procedure, the information to be used in the pre-verification is notified to the HeNB 400, so that the HeNB 400 is able to appropriately request the MME 300 to perform the verification (the pre-verification) of the UE 100.

In the present embodiment, the HeNB 400 holds the verification result obtained from the MME 300. When it is determined to perform the handover to the CSG cell, the eNB 200 transmits a handover request to the HeNB 400. The HeNB 400 determines whether to permit the handover request from the eNB 200 on the basis of the held verification result.

In this way, when it is determined to perform the handover to the CSG cell, the eNB 200 directly (that is, through the X2 interface) transmits the handover request to the HeNB 400, and the HeNB 400 determines whether to permit the handover request on the basis of a result of the pre-verification. Consequently, it is possible to quickly perform the handover to the CSG cell.

### Third Embodiment

Next, the mobile communication system according to a third embodiment will be described. In addition, portions different from the above-described first embodiment and the above-described second embodiment are mainly described and portions similar to the first embodiment and the second embodiment are appropriately omitted.

In the above-described first embodiment, the eNB 200 requests the MME 300 to perform the verification of the UE 100, but in the present embodiment, the HeNB GW 500 requests the MME 300 to perform the verification of the UE 100.

Hereinafter, (1) Overview of mobile communication system, (2) Block configuration, (3) Operation, and (4) Conclusion of embodiment will be sequentially described.

### (1) Overview of Mobile Communication System

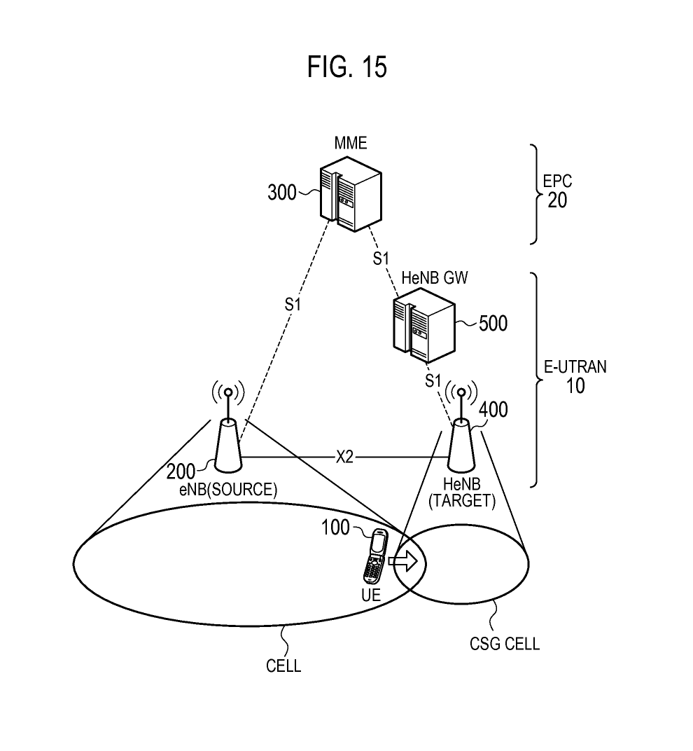

FIG. 15 is a configuration diagram of a mobile communication system according to the present embodiment.

In the present embodiment, the eNB 200 is able to communicate with the HeNB GW 500 through an X2 interface that is a logical communication path. Originally, the X2 interface is an interface for inter-base station communication. However, in the present embodiment, a case, in which it is not possible to establish the X2 interface between the eNB 200 and the HeNB 400, is considered, and the X2 interface is established between the eNB 200 and the HeNB GW 500. Accordingly, the HeNB GW 500 is connected to the eNB 200 through the X2 interface.

### (2) Block Configuration

Hereinafter, the block configurations of the eNB 200, the MME 300, and the HeNB GW 500 will be described.

(2.1) eNB

The network communication unit 220 communicates with the MME 300 through the S1 interface. In the present embodiment, the network communication unit 220 communicates with the HeNB GW 500 through the X2 interface.

In the present embodiment, before determining to perform the handover to the CSG cell, the control unit 240 notifies the HeNB GW 500 of information of each of the CSG cell and the UE 100 on the basis of the measurement report received from the UE 100. Specifically, the control unit 240 controls the network communication unit 220 to transmit a terminal verification message including the information of each of the CSG cell and the UE 100 to the HeNB GW 500 through the X2 interface. Furthermore, the information of the CSG cell, for example, includes an access mode (CSG/hybrid) and CSG ID. Furthermore, the information of the UE 100 includes identification information of the UE 100, and for example, includes RNTI (Radio Network Temporary ID).

Furthermore, when it is determined to perform the handover to the CSG cell, the control unit 240 controls the network communication unit 220 to transmit a handover request to the HeNB GW 500 through the X2 interface. After the handover request is transmitted, when a command of handover (HO Command) is received from the HeNB 400, the control unit 240 controls the radio transmission/reception unit 210 to transmit a command of the handover (HO Command) to the CSG cell to the UE 100.

After the handover request is transmitted, the control unit 240 may control the radio transmission/reception unit 210 to transmit the command of the handover (HO Command) to the CSG cell to the UE 100 in response to the reception of HO Request Ack that is received from the HeNB 400 via the HeNB GW 500.

(2.2) MME

In the present embodiment, when the network communication unit 310 receives a terminal verification request message from the HeNB GW 500 through the S1 interface, the control unit 330 performs verification of the UE 100 on the basis of CSD ID, the access mode, and the identification information of the UE 100, which are included in the terminal verification request message, and the CSG subscriber information stored in the storage unit 320.

When the CSD ID and the identification information of the UE 100, which are included in the terminal verification request message, are associated with the CSG subscriber information, the control unit 330 determines verification success and controls the network communication unit 310 to transmit a terminal verification response indicating the verification success to the HeNB GW 500 through the S1 interface. The terminal verification response includes the CSG ID, and status information (Membership status) indicating whether the UE 100 is a CSG member.

In addition, when the CSD ID and the identification information of the UE 100, which are included in the terminal verification request message, are not associated with the CSG subscriber information, the control unit 330 determines verification failure and controls the network communication unit 310 to transmit a terminal verification response indicating the verification failure.

(2.3) HeNB GW

The network communication unit 510 communicates with the MME 300 and the HeNB 400 through the S1 interface. In the present embodiment, the network communication unit 510 communicates with the eNB 200 through the X2 interface.

When the network communication unit 510 receives the terminal verification message from the eNB 200 through the X2 interface, the control unit 530 controls the network communication unit 510 to transmit the aforementioned terminal verification request message to the MME 300 through the S1 interface on the basis of the terminal verification message.

When the network communication unit 510 receives a terminal verification response indicating a verification result from the MME 300 through the S1 interface in response to the terminal verification message, the control unit 530 controls the storage unit 520 to hold the verification result.

Then, when the network communication unit 510 receives a handover request from the eNB 200 through the X2 interface, the control unit 530 determines whether to permit the handover request on the basis of the verification result held in the storage unit 520.

When determining to permit the handover request, the control unit 530 controls the network communication unit 510 to transmit the handover request to the HeNB GW 500 through the S1 interface.

### (3) Operation

Hereinafter, the operation of the mobile communication system according to the present embodiment will be described.

(3.1) Operation Sequence

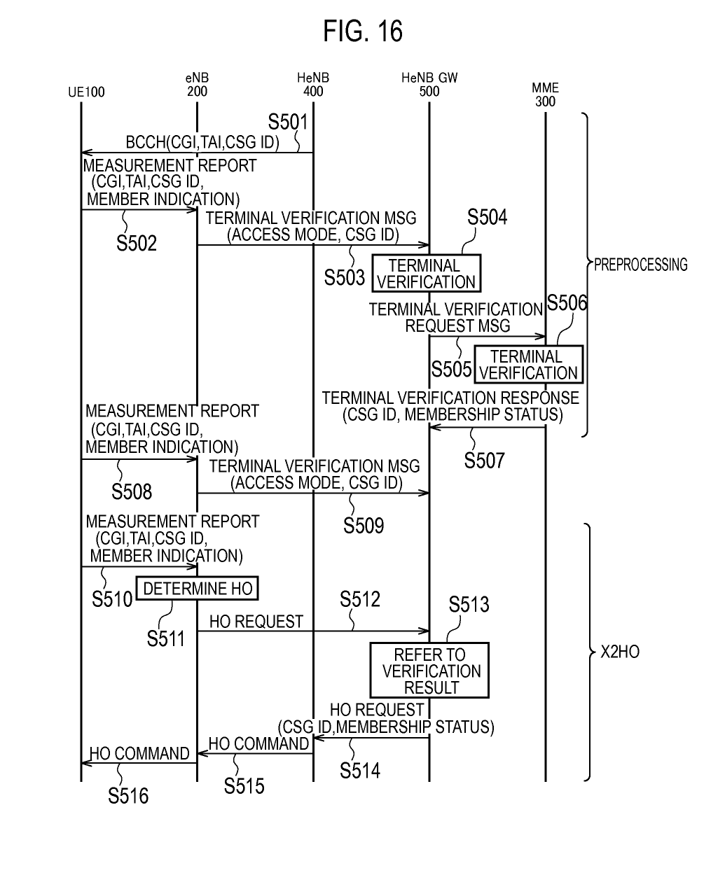

FIG. 16 is an operation sequence diagram of the mobile communication system according to the present embodiment. In the present sequence, a description will be provided for an operation when the UE 100 periodically transmits a measurement report.

As illustrated in FIG. 16, in step S501, the UE 100 receives broadcast information from the HeNB 400 through BCCH (Broadcast Control Channel). The broadcast information includes CGI, TAI, and CSG ID.

In step S502, the UE 100 transmits a measurement report including the CGI, the TAI, the CSG ID, and Member Indication to the eNB 200.

In step S503, the eNB 200 determines whether to perform handover of the UE 100 to the CSG cell on the basis of the measurement report from the UE 100. Hereafter, a description will be given on the assumption that the eNB 200 determines not to perform the handover of the UE 100 to the CSG cell. The eNB 200 transmits a terminal verification message to HeNB GW 500 through the X2 interface on the basis of the measurement report from the UE 100. The terminal verification message includes CSG ID and an access mode. Furthermore, the terminal verification message includes identification information of the UE 100.

In step S504, the HeNB GW 500 performs verification of the UE 100 on the basis of the terminal verification message from the eNB 200. For example, the HeNB GW 500 confirms whether the CSG ID included in the terminal verification message coincides with CSG ID of a CSG cell of the HeNB 400 managed by the HeNB GW 500. Hereinafter, a description will be given on the assumption that the verification is succeeded.

In step S505, the HeNB GW 500 transmits a terminal verification request message to the MME 300 through the S1 interface on the basis of the terminal verification message from the eNB 200. The terminal verification request message includes the CSD ID, the access mode, and the identification information of the UE 100.

In step S506, the MME 300 performs pre-verification of the UE 100, that is, confirms whether the UE 100 is a member UE on the basis of the CSD ID, the access mode, and the identification information of the UE 100, which are included in the terminal verification request message from the HeNB GW 500, and CSG subscriber information stored in advance.

In step S507, the MME 300 transmits a terminal verification response indicating a verification result in step S506 to the HeNB GW 500 through the S1 interface. The terminal verification response includes the CSG ID, and status information (Membership status) indicating whether the UE 100 is a CSG member. When the terminal verification response is received from the MME 300, the HeNB GW 500 holds the terminal verification response as the verification result of the pre-verification.

In step S508, the UE 100 transmits the measurement report including the CGI, the TAI, the CSG ID, and the Member Indication to the eNB 200.

In step S509, the eNB 200 determines whether to perform the handover of the UE 100 to the CSG cell on the basis of the measurement report from the UE 100. Hereafter, a description will be given on the assumption that the eNB 200 determines not to perform the handover of the UE 100 to the CSG cell. The eNB 200 transmits a terminal verification message to HeNB GW 500 through the X2 interface on the basis of the measurement report from the UE 100. The terminal verification message includes CSG ID and an access mode. Furthermore, the terminal verification message includes identification information of the UE 100.

When the terminal verification message is received from the eNB 200, the HeNB GW 500 ignores the terminal verification message because the HeNB GW 500 has already held the pre-verification result.

In step S510, the UE 100 transmits the measurement report including the CGI, the TAI, the CSG ID, and the Member Indication to the eNB 200.

In step S511, the eNB 200 determines whether to perform the handover of the UE 100 to the CSG cell on the basis of the measurement report from the UE 100. Hereafter, a description will be given on the assumption that the eNB 200 determines to perform the handover of the UE 100 to the CSG cell. From the time point at which the eNB 200 determines to perform the handover, a preparation stage (HO Preparation) in the handover procedure is started.

In step S512, the eNB 200 transmits a handover request (HO Request) for requesting acceptance of the UE 100 to the HeNB GW 500 through the X2 interface.

In step S513, the HeNB GW 500 determines whether to permit the handover request from the eNB 200 with reference to the pre-verification result obtained in step S507. Specifically, the HeNB GW 500 determines to permit the handover request when the pre-verification result obtained in step S507 indicates verification success. The HeNB GW 500 determines to reject the handover request when the pre-verification result obtained in step S507 indicates verification failure. Hereafter, a description will be given on the assumption that the HeNB GW 500 determines to permit the handover request.

In step S514, the HeNB GW 500 transmits a handover request for the handover to the CSG cell to the HeNB 400 through the S1 interface. The handover request includes the CSG ID of the CSG cell, and status information (Membership Status) indicating whether the UE 100 is a member UE of the CSG cell.

In step S515, the HeNB 400 determines acceptance to the CSG cell in response to the handover request from the HeNB GW 500, and transmits a command of the handover (HO Command) to the CSG cell to the eNB 200.

In step S516, the eNB 200 transmits a command of handover (HO Command) to the CSG cell to the UE 100 in response to the handover command (HO Command) from the HeNB 400.

In addition, in step S515, the HeNB 400 may transmit HO Request Ack to the eNB 200 through the HeNB GW 500, instead of directly transmitting the handover command (HO Command) to the eNB 200. In this case, in step S516, the eNB 200 transmits the command of the handover (HO Command) to the CSG cell to the UE 100 in response to the HO Request Ack from the HeNB 400.

(3.2) Operation of HeNB

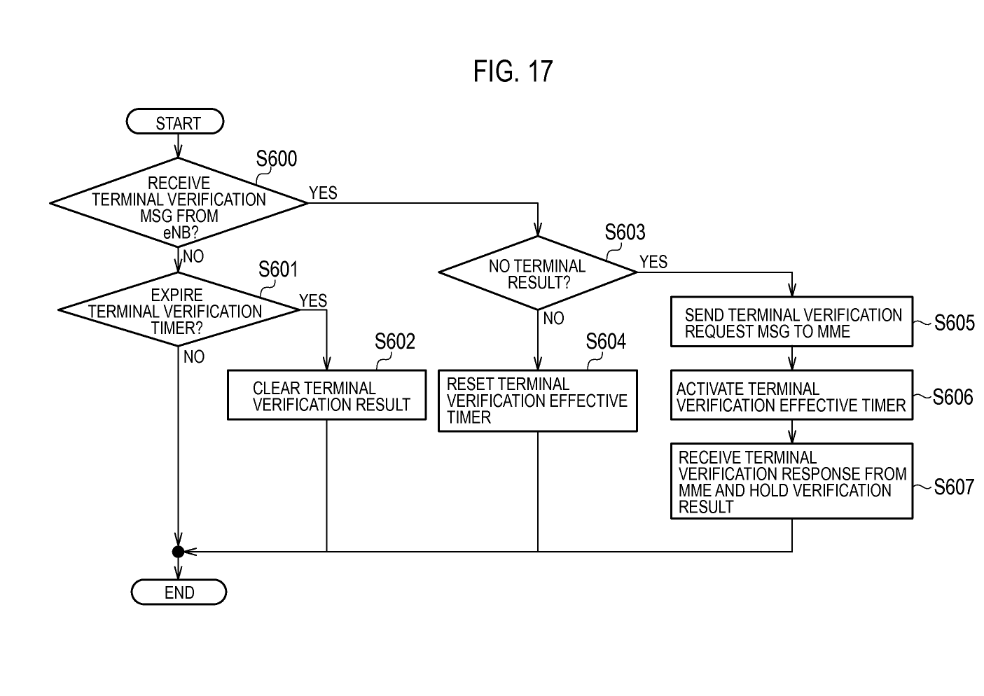

FIG. 17 is an operation flowchart of the HeNB GW 500. In the present flow, the HeNB GW 500 manages a pre-verification result using a terminal verification timer.

As illustrated in FIG. 17, in step S600, the HeNB GW 500 confirms whether a terminal verification message has been received from the eNB 200.

When the terminal verification message has not been received from the eNB 200 (step S600; No), the HeNB GW 500 confirms whether the terminal verification timer has expired in step S601. When the terminal verification timer has expired (step S601; Yes), the HeNB GW 500 discards (clears) the held pre-verification result in step S602.

Meanwhile, when the terminal verification message has been received from the eNB 200 (step S600; Yes), the HeNB GW 500 confirms whether the pre-verification result has been held in step S603. When pre-verification has been not performed or when the pre-verification has already been performed but the pre-verification result has been discarded due to time-out, it is regarded that the HeNB GW 500 has not held the pre-verification result.

When the pre-verification result has been held (step S603; No), the HeNB GW 500 resets the terminal verification timer in step S604.

On the other hand, when the pre-verification result has not been held (step S603; Yes), the HeNB GW 500 transmits the aforementioned terminal verification request message to the MME 300 in step S605. Then, the HeNB GW 500 activates the terminal verification timer (step S606), and receives and holds the pre-verification result from the MME 300 (step S607).

### (4) Conclusion of Embodiment

As described above, in the mobile communication system including the HeNB 400 configured to form the CSG cell, the eNB 200 configured to determine whether to perform the handover of the UE 100 to the CSG cell, the MME 300 configured to perform the verification of the UE 100 for access permission to the CSG cell, and the HeNB GW 500 configured to manage the HeNB 400, the HeNB GW 500 requests the MME 300 to perform the verification of the UE 100 before the eNB 200 determines to perform the handover to the CSG cell.

In this way, the MME 300 performs the verification (that is, the pre-verification) of the UE 100 at a stage before the handover procedure, so that it is possible to omit the verification of the UE 100 by the MME 300 in the course of the handover procedure. Furthermore, it is possible to ensure that the MME 300 does not intervene in the handover procedure, resulting in the reduction of signaling to the MME 300.

In the present embodiment, before determining to perform the handover to the CSG cell, the eNB 200 notifies the HeNB GW 500 of information of each of the CSG cell and the UE 100 on the basis of the measurement report received from the UE 100. The HeNB GW 500 requests the MME 300 to perform the verification of the UE 100 on the basis of the information notified from the eNB 200.

In this way, at a stage before the handover procedure, the information to be used in the pre-verification is notified to the HeNB GW 500, so that the HeNB GW 500 is able to appropriately request the MME 300 to perform the verification (the pre-verification) of the UE 100.

In the present embodiment, the HeNB GW 500 holds the verification result obtained from the MME 300. When it is determined to perform the handover to the CSG cell, the eNB 200 transmits a handover request to the HeNB GW 500. The HeNB GW 500 determines whether to permit the handover request from the eNB 200 on the basis of the held verification result.

In this way, when it is determined to perform the handover to the CSG cell, the eNB 200 directly (that is, through the X2 interface) transmits the handover request to the HeNB GW 500, and the HeNB GW 500 determines whether to permit the handover request on the basis of a result of the pre-verification. Consequently, it is possible to quickly perform the handover to the CSG cell.

### Other Embodiments

Thus, the present invention has been described with the embodiment. However, it should not be understood that those descriptions and drawings constituting a part of the present disclosure limit the present invention.

For example, in the aforementioned embodiment, the handover procedure to the CSG cell has been mainly described. However, the present invention may also be applied to a handover procedure to a hybrid cell.

It is noted that the entire content of U.S. Provisional Application No. 61/612,049 (filed on Mar. 16, 2012), U.S. Provisional Application No. 61/612,003 (filed on Mar. 16, 2012), and U.S. Provisional Application No. 61/612,014 (filed on Mar. 16, 2012) are incorporated in the present specification by reference.

### INDUSTRIAL APPLICABILITY

As mentioned above, the communication control method, the base station, the home base station, and the gateway device according to the present invention are beneficial in the mobile communication field because it is possible for the communication control method, the base station, the home base station, and the gateway device to efficiently perform the handover procedure to the specific cell.

1. A communication control method applied to a mobile communication system, the mobile communication system including:
a home base station that forms a specific cell;
a base station that determines whether to perform handover of a user terminal to the specific cell; and
a mobility management device that performs verification of the user terminal for access permission to the specific cell, the communication control method comprising:
a request step of requesting the mobility management device to perform the verification of the user terminal before the base station determines to perform the handover to the specific cell.

2. The communication control method according to claim 1, in the request step, the base station requests the mobility management device to perform the verification of the user terminal.

3. The communication control method according to claim 2, further comprising: a step of holding, by the base station, a verification result obtained from the mobility management device.

4. The communication control method according to claim 3, further comprising: a step of transmitting, by the base station, a handover request to the home base station when the base station determines to perform the handover to the specific cell on the basis of a measurement report from the user terminal and when a verification result indicating verification success is obtained from the mobility management device.

5. The communication control method according to claim 4, further comprising: a step of requesting, by the base station, the mobility management device to perform the verification of the user terminal when the base station determines to perform the handover to the specific cell on the basis of the measurement report from the user terminal and when the verification result indicating the verification success is not obtained from the mobility management device.

6. The communication control method according to claim 3, further comprising: a step of transmitting, by the base station, information on the verification result from the mobility management device to the home base station together with a handover request when the base station determines to perform the handover to the specific cell on the basis of a measurement report from the user terminal.

7. The communication control method according to claim 6, further comprising: a step of permitting, by the home base station, the handover request from the base station in response to a fact that information on the verification result from the base station indicates verification success.

8. The communication control method according to claim 6, further comprising: a step of requesting, by the home base station, the mobility management device to perform the verification of the user terminal in response to a fact that the information on the verification result from the base station indicates that a verification result indicating verification success is not obtained.

9. The communication control method according to claim 1, in the request step, the home base station requests the mobility management device to perform the verification of the user terminal.

10. The communication control method according to claim 9, further comprising: a notification step of notifying, by the base station, the home base station of information of each of the specific cell and the user terminal on the basis of a measurement report received from the user terminal before determining to perform the handover to the specific cell, wherein
in the request step, the home base station requests the mobility management device to perform the verification of the user terminal on the basis of the information notified from the base station.

11. The communication control method according to claim 9, further comprising: a holding step of holding, by the home base station, a verification result obtained from the mobility management device in response to a request in the request step.

12. The communication control method according to claim 11, further comprising:
a transmission step of transmitting, by the base station, a handover request to the home base station when the base station determines to perform the handover to the specific cell; and
a step of determining, by the home base station, whether to permit the handover request from the base station on the basis of the verification result held in the holding step.

13. The communication control method according to claim 1, further the mobile communication system includes a gateway device that manages the home base station,
in the request step, the gateway device requests the mobility management device to perform the verification of the user terminal.

14. The communication control method according to claim 13, further comprising:
a notification step of notifying, by the base station, the gateway device of information of each of the specific cell and the user terminal on the basis of a measurement report received from the user terminal before determining to perform the handover to the specific cell, wherein
in the request step, the gateway device requests the mobility management device to perform the verification of the user terminal on the basis of the information notified from the base station.

15. The communication control method according to claim 13, further comprising: a holding step of holding, by the gateway device, a verification result obtained from the mobility management device in response to a request in the request step.

16. The communication control method according to claim 15, further comprising:
a transmission step of transmitting, by the base station, a handover request to the gateway device when the base station determines to perform the handover to the specific cell; and
a step of determining, by the gateway device, whether to permit the handover request from the base station on the basis of the verification result held in the holding step.

17. A base station, which determines whether to perform handover of a user terminal to a specific cell in a mobile communication system including a home base station that forms a specific cell and a mobility management device that performs verification of the user terminal for access permission to the specific cell, comprising:
a control unit that controls to request the mobility management device to perform the verification of the user terminal before it is determined to perform the handover to the specific cell.

18. A home base station that forms a specific cell in a mobile communication system including a base station that determines whether to perform handover of a user terminal to the specific cell and a mobility management device that performs verification of the user terminal for access permission to the specific cell, comprising:
a control unit that controls to request the mobility management device to perform the verification of the user terminal before the base station determines to perform the handover to the specific cell.

19. A base station that determines whether to perform handover of a user terminal to a specific cell in a mobile communication system including a home base station that forms a specific cell and a mobility management device that performs verification of the user terminal for access permission to the specific cell, comprising:
a control unit that controls to notify the home base station of information of each of the specific cell and the user terminal on the basis of a measurement report received from the user terminal before determining to perform the handover to the specific cell, wherein
the information notified by the control unit is used when the home base station requests the mobility management device to perform the verification of the user terminal.

20. A gateway device that manages a home base station in a mobile communication system including the home base station that forms a specific cell, a base station that determines whether to perform handover of a user terminal to the specific cell, and a mobility management device that performs verification of the user terminal for access permission to the specific cell, comprising:
a control unit that controls to request the mobility management device to perform the verification of the user terminal before the base station determines to perform the handover to the specific cell.

21. A base station that determines whether to perform handover of a user terminal to a specific cell in a mobile communication system including a home base station that forms a specific cell, a mobility management device that performs verification of the user terminal for access permission to the specific cell, and a gateway device that manages the home base station, comprising:
a control unit that controls to notify the gateway device of information of each of the specific cell and the user terminal on the basis of a measurement report received from the user terminal before determining to perform the handover to the specific cell, wherein
the information notified by the control unit is used when the gateway device requests the mobility management device to perform the verification of the user terminal.
